(19) United States
(12) Patent Application Publication
(10) Pub. No.: US 2010/0260862 A1
(43) Pub. Date: Oct. 14, 2010

(54) TIME RELEASE FORMULATIONS AND METHODS OF MAKING SAME

(76) Inventor: Daniel Cox, Elon, NC (US)

Correspondence Address: MITCHELL P. BROOK;LUCE, FORWARD, HAMILTON & SCRIPPS LLP, 600 West Broadway, Suite 2600, SAN DIEGO, CA, 92101, US

(21) Appl. No.: 12/756,039

(22) Filed: Apr. 7, 2010

Related U.S. Application Data
(60) Provisional application No. 61/167,771, filed on Apr. 8, 2009.

(51) Int. Cl. A01N 63/02; A01N 65/06; A01N 65/40; A01N 65/20; A01P 17/00

(52) U.S. Cl. 424/545; 424/770; 424/754; 424/731

(57) ABSTRACT

Time release repellent formulations and methods of making formulations, comprising a natural repellent, alum in an amount effective to keep microbial count below a pre-determined level and a natural binder. The natural repellent may be animal urine or a natural oil. The natural binder is selected from the group consisting of: rice, pearlite, polymer, peat moss, clay and foam. The pH level of the formulation is maintained within a pre-determined range by adding a natural acid to lower the pH level or adding a natural base to raise the pH level.

### CROSS-REFERENCE TO RELATED APPLICATION

This application claims priority to Patent Application Ser. No. 61/167,771, filed Apr. 8, 2009, and incorporated by reference herein in its entirety.

### FIELD

The present invention relates to time release formulations and methods.

### BACKGROUND

Insect and other pest repellents, attractants and fertilizers are used to grow crops for food consumption and other uses. Time release formulations have been developed to help control pests for the long periods of time necessary to grow and harvest food crops. However, known time release formulations of fertilizers, attractants and pest repellents only last up to about four weeks with a single application and must be applied multiple times over the course of growing and harvesting many types of crops. The cost of multiple applications can be significant. Adding to this cost is the fact that different repellents are needed for different crops because different pests may be attracted to each crop.

In addition, the amount of repellent released by these formulations is not always known, and the repellent is not consistently released over the operational time period. One reason for this uncertainty is that water coming into contact with the formulation can change the release factors of the product.

Known time release repellents also raise environmental concerns. In particular, another disadvantage of known time release repellents is that the release factors typically comprise chemicals that damage the environment. The current bug and micro bug (nematode) problems in commercial farming have made it necessary to use very strong environmentally damaging chemicals to treat the ground before planting; these poisons contaminate ground water and become air born, by leaching. Leaching often occurs over the course of the period the repellents are used, causing the hazardous chemicals in the release factors to pollute the environment. These chemicals typically linger in the ground or in groundwater runoff. The need for these strong chemicals has been in conflict with environmental laws, and in some countries completely destroyed commercial farming. There is a need for an environmentally friendly non-poisonous alternative so that millions of acres of land can be reclaimed to grow food.

Often too, the chemicals in repellents kill the pests, which can lead to ecological problems. If a particular pest micro-population is wiped out in an area, the population of an animal or insect lower in the food chain could skyrocket out of control. As the dead bugs killed by the poisons being used decompose, the fungus and microbes that break them down become immune to the poisons creating a worse long term problem. These microbes can jump by combining with other microbes to create diseases that can wipe out crops.

Therefore, there exists a need for a time release fertilizer, attractant and repellent universally applicable to all crops that lasts a long time and does not need to be re-applied over the course of a growing and harvest season. There also is a need for a time release fertilizer, attractant and repellent that is consistently released over the operational time period. There is a further need for a time release fertilizer, attractant and repellent made of organic ingredients that biodegrade and do not damage the environment. Finally, there is a need for a time release repellent that repels pests without killing them.

### SUMMARY

The present invention, in its many embodiments, alleviates to a great extent the disadvantages of known time release fertilizer, attractant and repellent formulations. Time release fertilizers, attractants and repellents and methods of making time release formulations are provided in which various natural ingredients are used as repellents and used to maintain consistent pH and keep microbial counts low and a natural binder or substrate/carrier is used to bond and absorb the ingredients. With consistent pH, the time release formulation provides uniform results and uniform length of release.

In some embodiments, the natural ingredients used to maintain consistent pH comprise soda ash to lower the pH and citric acid to raise the pH, the natural antimicrobial comprises alum, for example, in crystal form, and the natural binder or substrate may comprise rice, pearlite, polymer, clay, fiber or foam. The substrate acts as the end carrier to which the formulation is bound. Coconut oil may be used to facilitate absorption of oils in the substrate.

Embodiments of disclosed formulations comprise urine from a first animal in an amount effective to repel a second animal, a natural oil, alum (for example, a natural mineral alum) in an amount effective to keep the microbial count of the formulation below a pre-determined level, and a natural binder. The use of alum separates the microbial action from the actions of other ingredients that relate to the length of time the formulation stays fresh. Advantageously, the alum also acts to remove any natural spoiling or rotting that might occur in the formulation ingredients. The pH level is maintained within a pre-determined range by adding a natural acid to lower the pH level or adding a natural base to raise the pH level. The natural oil may be garlic oil, and the natural binder is selected from the group consisting of: rice, pearlite, polymer, moss, clay and foam. The natural acid may be citric acid, and the natural base may be any known natural base, for example, soda ash.

Another embodiment of a disclosed formulation comprises one or more natural oils, lemon grass, lemon eucalyptus, and a natural binder. The pH level is maintained within a pre-determined range by adding soda ash to lower the pH level or adding citric acid to raise the pH level. The one or more natural oils may comprise cedar wood oil and garlic oil, and the natural binder is selected from the group consisting of: rice, pearlite, polymer, moss, clay and foam, or any absorbing material or water soluble material such as soap.

An embodiment of a method of making a time release formulation comprises providing a natural repellent, providing a natural binder, and optionally providing a natural antimicrobial agent. The natural repellent, the natural binder and the natural antimicrobial agent are combined and heated air is pulled through the combined ingredients until they are substantially dry. The pH level is maintained within a pre-determined range, for example, by adding soda ash to lower the pH level or adding citric acid to raise the pH level. The natural repellent may comprise animal urine or a natural oil, which may comprise cedar wood oil and/or garlic oil. The natural binder is selected from the group consisting of: rice, pearlite, polymer, moss, clay and foam or any absorbing material, or water soluble material such as soap.

Embodiments of the present disclosure provide a time release mechanism to time release repellents, attractants and fertilizers so the products can be used without leaching or polluting the environment. Embodiments further provide a time release mechanism that provides a controlled release of active ingredients to prolong the life cycle of the product. Embodiments provide a time release mechanism that may be activated by moisture in the air. Embodiments provide a time release mechanism that will not be washed out by high water pressure. Embodiments further provide a time release mechanism that lasts for a determined time and can be altered to provide a particular desired time release action.

Accordingly, it is seen that time release repellent formulations and methods of making time release repellent formulations is disclosed. These and other features of the present disclosure will be appreciated from review of the following detailed description, along with the accompanying figures.

### BRIEF DESCRIPTION OF THE DRAWINGS

The foregoing and other objects of the invention will be apparent upon consideration of the following detailed description, taken in conjunction with the accompanying drawings, in which:

FIG. 1 shows an embodiment of a dryer used in disclosed methods of making time release formulations in accordance with the present invention;

FIG. 2 shows a cross-sectional view of an embodiment of a dot delivery apparatus in accordance with the present invention;

FIG. 3 shows embodiments of a dot delivery apparatus used in an outdoor area;

FIG. 4 shows embodiments of a dot delivery apparatus used in an indoor area;

FIG. 5 shows a perspective view of an embodiment of a bag delivery apparatus in accordance with the present invention;

FIG. 6 shows embodiments of a bag delivery apparatus used in an indoor area;

FIG. 7 shows a perspective view of an embodiment of a candle delivery apparatus in accordance with the present invention;

FIG. 8 shows a front view of an embodiment of a sticker delivery apparatus in accordance with the present invention; and

FIG. 9 shows a front view of an embodiment of a dryer sheet delivery apparatus in accordance with the present invention.

### DETAILED DESCRIPTION

In the following paragraphs, embodiments of the present disclosure will be described in detail by way of example with reference to the accompanying drawings, which are not drawn to scale, and the illustrated components are not necessarily drawn proportionately to one another. Throughout this description, the embodiments and examples shown should be considered as exemplars, rather than as limitations of the present disclosure. As used herein, the “present disclosure” refers to any one of the embodiments described herein, and any equivalents. Furthermore, reference to various aspects of the disclosure throughout this document does not mean that all claimed embodiments or methods must include the referenced aspects. Reference to volume, pH, temperature, pressure, percentage, proportion, density and other parameters should be considered as representative and illustrative of the capabilities of disclosed embodiments, and embodiments can operate with a wide variety of such parameters.

The examples of liquid, and solid products used and produced by various disclosed embodiments are not intended to be comprehensive. Some minor products of embodiments of the disclosure, including those that form temporarily and then dissolve, will not be discussed in great detail below but are understood to be included within the scope of the disclosure.

### Example 1

### Bug Repellent

The ingredients in embodiments of time release bug repellent formulations comprise cedar wood oil, garlic oil, lemon grass and lemon eucalyptus. All the oils have 40 ml of alum added to the container per gallon. This is to preserve them and maintain a low microbial count, for example, at or below about 100 parts per million contamination. It should be noted that the use of alum separates the microbial action from the length of time the formulation stays fresh. Other natural antimicrobials could used instead of alum such at tea tree extract or alcohol. Next the pH is checked using a strip test kit or any other method of checking pH known in the art. The pH is adjusted to around 9 on all the oils, but could be in the range of about 7.0 to about 9.5. This is to make it very active and to insure uniform results between batches. The pH is altered by adding citric acid to lower the pH or soda ash to increase it. Variation in pH level is desirable so the animal being repelled does not get used to a particular pH level.

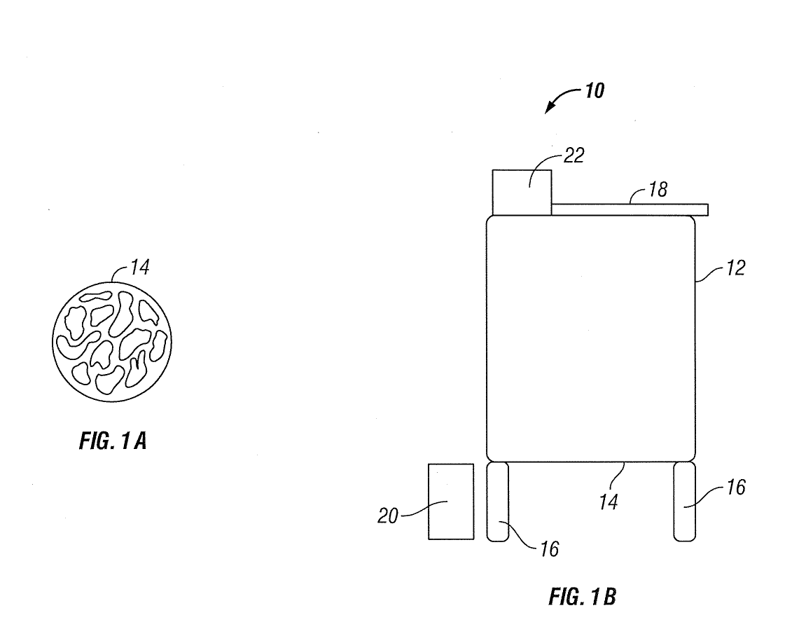

Next the oils are added at a rate of 1 oz per gallon to water. This mixture may not readily mix so 1 oz of coconut oil per gallon should be added. This works as an emulsifier, allowing the oil and water to mix and can be seen by the coloring mixing as well. Coloring may be added if desired at a rate of 50 ml per gallon. Next the 1 gallon oil mixture is added to 30 pounds of rice or pearlite, or any other natural binder or carrier, including but not limited to, polymer, moss, clay or foam. Pearlite is the an example of a binder that can be used and is the best absorbing binder. However, any natural binder or substrate that is soluble in water may be used. The oil mixture and binder is mixed well, then the mix is dried by pulling heated air through the mix until it reaches 10 relative humidity (“RH”) using the drum apparatus shown in FIG. 1 and discussed in detail below. This process is repeated with all 5 of the ingredients then the 5 dry batches are mixed together evenly to create a time release bug repellent. The product can be modified by adding parrifin wax or soap to the wet mix to slow the rate at which the substrate aborbs water. This slows the release of the active ingredient and makes the attractant, repellent or fertilizer last longer. This formulation repels all types of bugs, including but not limited to insects, nematodes, spiders, fleas, ticks, mosquitoes, flies, chiggers, gnats and flies.

### Example 2

### Goose and Fowl Repellent

The ingredients for embodiments of time release goose and fowl repellent formulations comprise red fox urine, garlic oil, alum (for example, in crystal form) and rice or pearlite as a binder, or other natural binders such as peat moss, polymer or others known in the art. The urine has 100 ml of alum added to 1 gallon. This is to keep it fresh and preserve it. Particularly, the alum maintains a low microbial count, for example, at or below about 100 parts per million contamination. Other natural antimicrobials could used instead of alum such at tea tree extract or alcohol. Next the urine is pH tested and adjusted to be more acidic, around 5 on the pH scale, or in the range of about 4.0 to about 6.5. This is done by adding citric acid. Next the garlic oil is added at a rate of 1 oz to 50 pounds of rice. Then the urine is colored green by adding 0.25 oz of color per gallon of urine. Then the urine is mixed into the rice at a rate of 2 gallons per 50 pounds. The mixture is dried by pulling heated air threw the mix until it is around 10 RH using the drum apparatus shown in FIG. 1 and discussed in detail below. This formulation repels geese, ducks and other birds, as well as cats.

### Example 3

### Deer Repellent

The ingredients for embodiments of time release deer repellent formulation comprise coyote urine, alum (for example, crystal form) and rice or pearlite as a binder. The urine has 50 ml of alum added to 1 gallon. This is to keep it fresh and preserve it. Particularly, the alum maintains a low microbial count, for example, at or below about 100 parts per million contamination. Other natural antimicrobials could used instead of alum such at tea tree extract or alcohol. Next the urine is pH tested and adjusted to be more acidic, around 5 on the pH scale, or in the range of about 3.0 to about 6.6. This is done by adding citric acid. Then the urine is colored brown by adding 0.25 oz of color per gallon of urine. Then the urine is mixed into the rice at a rate of 1-2 gallons per 50 pounds of rice. Many other substrates can be used, such as polymer or peat moss. The mixture is dried by pulling heated air through the mix using the drum apparatus shown in FIG. 1 and discussed in detail below. This formulation repels large animals such as deer, skunks, raccoons and turkeys.

### Example 4

### Snake and Rat Repellent

The ingredients for embodiments of time release snake and rat repellent formulations comprise lime juice, alum (for example, in crystal form) and rice or pearlite as a binder. The alum is dissolved in water at a rate of 1 oz per gallon. This is to maintain a low microbial count, for example, at or below about 100 parts per million contamination. The alum also serves to repel snakes. Other natural antimicrobials could be used instead of alum such as tea tree extract or alcohol. Then two oz of lime juice is added to the mix, which is added to the rice or other substrate at a rate of 1-3 gallon per 30 pounds. The mixture is pH tested and adjusted to be more acidic, around 5 on the pH scale, or in the range of about 4 to about 5. This can be done by adding a natural acid, for example, citric acid. The mixture is dried by pulling heated air through the mix using the drum apparatus shown in FIG. 1 and discussed in detail below. This formulation repels snakes and rats.

### Example 5

### Mole and Vole Repellent

The ingredients for embodiments of time release mole-vole repellent formulations comprise castor oil, alum (for example, crystal form) and a natural binder, for example, rice or pearlite. Alum is added to the castor oil at a rate of 40 ml per 1 gallon. This is to keep it fresh and preserve it. Particularly, the alum maintains a low microbial count, for example, at or below about 100 parts per million contamination. The castor oil does not need to be pH tested because pests such as moles and voles are particular susceptible to diuretics such as castor oil. The castor oil-alum mixture is mixed into the rice at a rate of 2 gallons per 50 pounds of rice. Many other substrates can be used, such as polymer or peat moss. The mixture is dried by pulling heated air through the mix using the drum apparatus shown in FIG. 1 and discussed in detail below. This formulation repels small rodents such as mice, rats, moles, chipmunks, voles, etc.

It should be noted that in the above examples, the repellent-alum mixture can be mixed into the binder/substrate using various rates and proportions depending on such factors as how long the formulation needs to last and the volume or number of pests to be repelled. The range could be from about ½ gallon to about 10 gallons of the repellent-alum mixture per 50 pounds of binder/substrate. The binder/substrate is first poured into a mixing pan then the repellent-alum mixture is poured in, and the combined ingredients are mixed. The combined ingredients need to sit for about 15-30 minutes so the binder/substrate, whether rice, pearlite or another natural binder, can absorb the repellent-alum mixture. After about 15-30 minutes, the combined ingredients should be flipped, using a shovel or other similar tool, and if any liquid remains the ingredients should continue to sit until the binder/substrate absorbs all of the repellent-alum mixture.

An illustrative drying apparatus and process for making the disclosed time release formulations is shown in FIG. 1. The drying apparatus 10 (or “dry down machine”) comprises a barrel or drum 12 with a screened bottom 14. The drum 12 may have legs 16 fixed to the bottom, for example, by welding, and a lid 18. The legs 16 elevate the drum 12 to a sufficient height such that a heater 20 can be placed under the drum. Any type of forced air heater can be used, and may include an electric heater coil with a fan behind it. A larger heater will dry the formulation mixture faster. An operative temperature range for the heater is 75-100° F., for example, approximately 90° F. Temperatures at or above about 120° F. will disadvantageously break down the minerals in the formulation mixture. The formulation mixture is poured into the drum 12. A fan 22 is placed on top of the drum 12 to pull the heated air up through the mixture to rapidly and consistently pull out the moisture and dry the formulation. The formulation mixture is dried rapidly to maintain the mineral content, in a period of about one hour to 1 and ½ hours.

The end product may be a rice or pearlite granular and works generally as follows. According to the preparation process described above, the rice soaks up the formulation. Then the rice is dried in the drying apparatus 10, which removes the water but leaves the solid components of the formulation. After the rice is distributed at the desired location, it absorbs water from the air or environment and releases the mineral components along with the moisture it has absorbed over a pre-determined time frame.

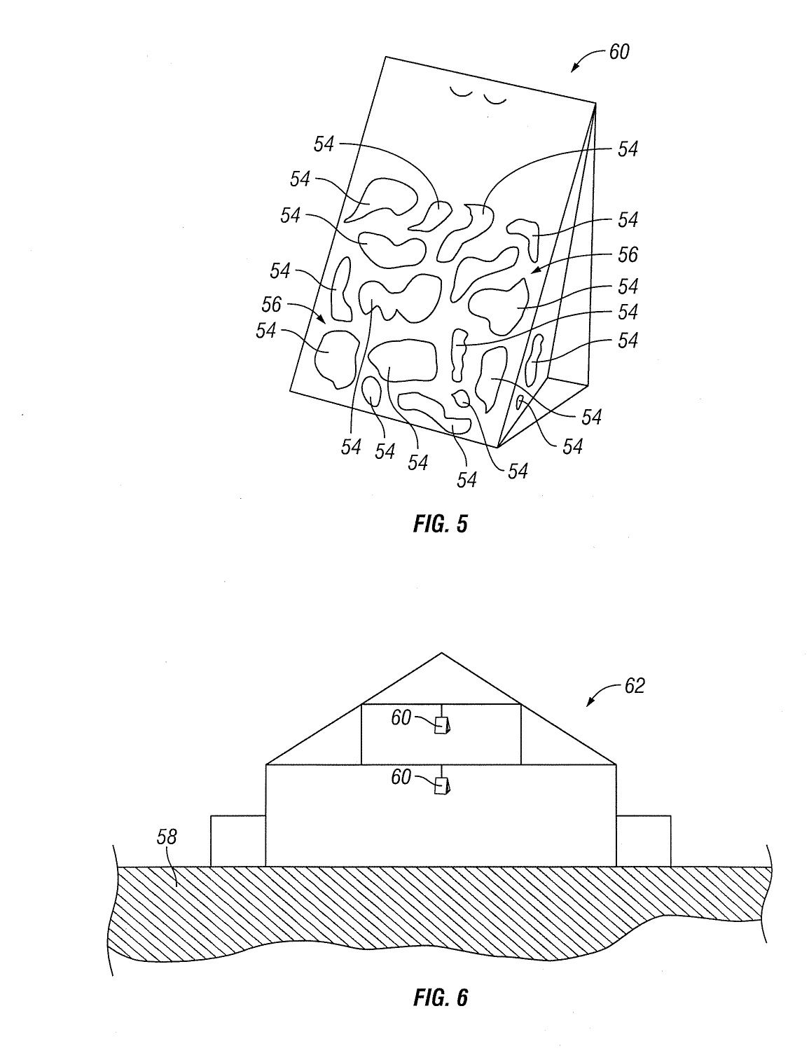

Some examples of delivery methods include placing the granular products 56 (rice, polymer or pearlite, etc.) and repellent 54 into a tea bag type bag delivery apparatus 60 that is permeable by air, as shown in FIG. 5. The bag delivery apparatus 60 can be very large to cover and protect a large area. As shown in FIG. 6, by placing it in a tea bag delivery apparatus 60 the machinery is readily available and the ability to raise the product up several feet above the ground provides a larger area of coverage.

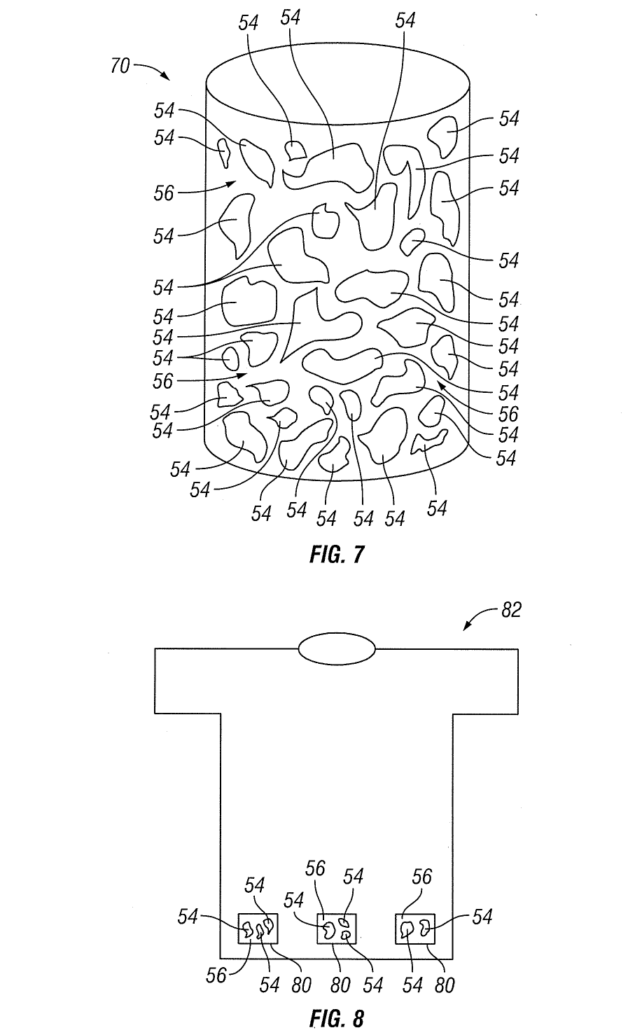

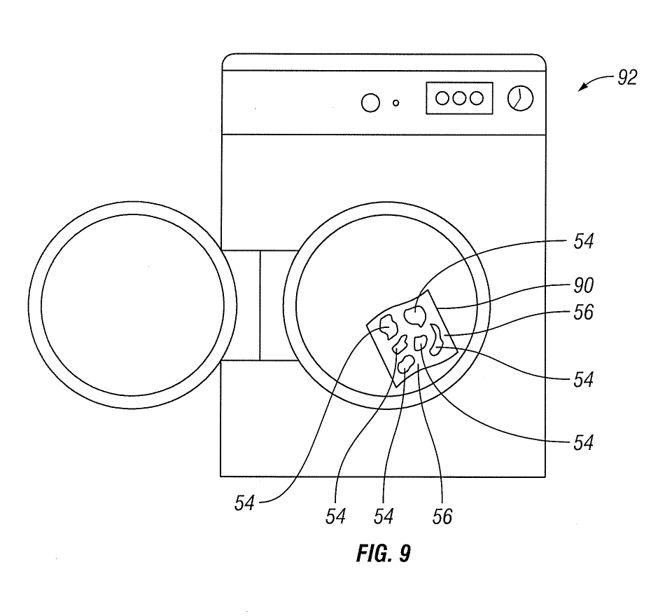

As shown in FIG. 7, the repellent product also could be placed into a wax candle-like delivery apparatus 70 that will repel bugs from an outdoor space. The candle delivery apparatus 70 does not need to be burned just scraped every day or so. Other delivery methods include applying the bug repellent to sticker delivery apparatus 80 that can be worn on clothing 82 to protect the wearer from bugs, as shown in FIG. 8. As shown in FIG. 9, the formulation can also be placed into a dryer sheet delivery apparatus 90 and used in a dryer 92 to treat the clothing it is used with.

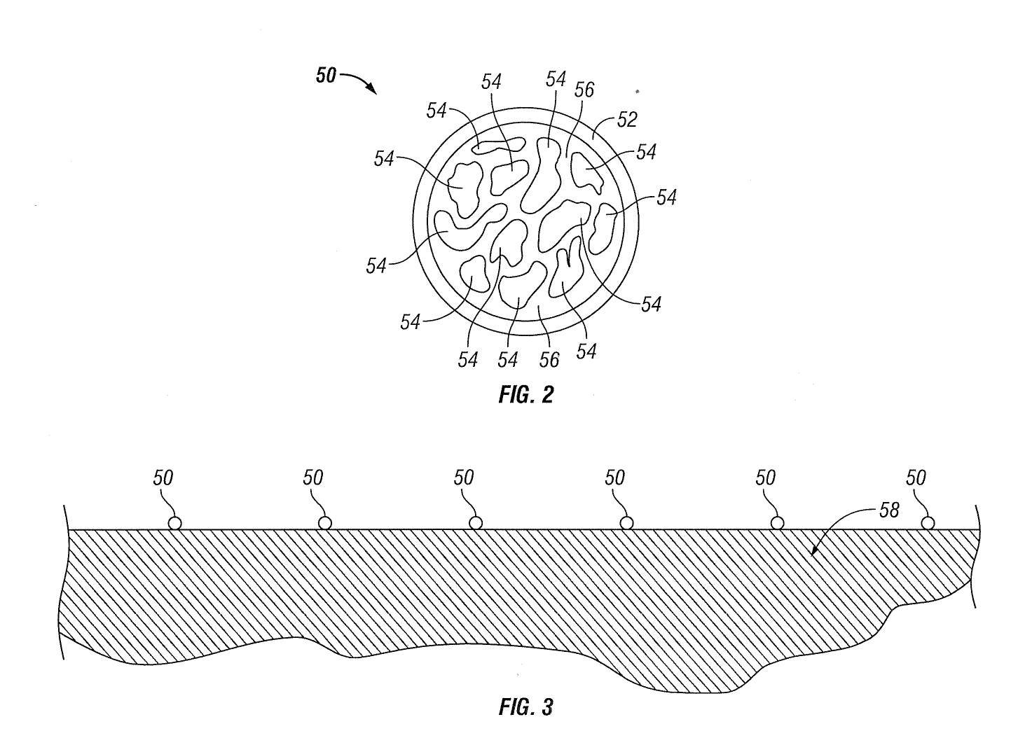

In another example of a delivery method, the bug repellent formulation, including both repellent 54 and binder 56 can be injected into a dot delivery apparatus 50 (also called a green dot). As shown in FIG. 2, the dot delivery apparatus 50 may be sealed in by wax 52. As the wax 52 breaks down from the sun, rain or other elemental conditions, it steadily releases the repellent 54 into the air. The dot delivery apparatus 50 varies in color depending on which animal or pest is being repelled. Bug dots are green. Dots that repel deer, skunks, raccoons and turkeys may be light green. Blue dots repel geese, ducks, cats, birds, etc. White dots repel snakes, mice, rats, chipmunks and other rodents. A soil dot is dirty white and repels fungi, nematodes, and any bug or microbe that eats crop roots.

The dot delivery apparatus 50 can be made from any foam or natural fiber, and the release factors change depending on the substrate. Any of the above examples can be incorporated into the dot delivery system. Alum is added to the oils and/or urines as discussed above with respect to the individual examples. The urine and/or oil is mixed into the substrate, evenly mixed to allow the liquids to be absorbed. The wet mix is placed into the drying apparatus and dried, as discussed above, to 10% relative humidity. The dot should be stored sealed until use.

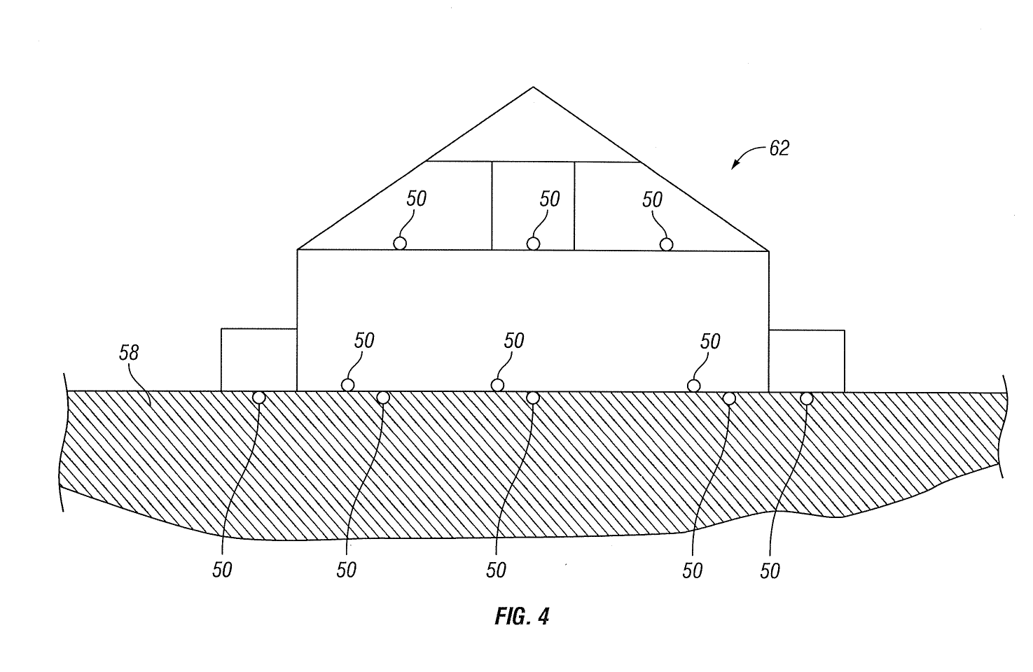

The dot delivery apparatus 50 varies in size. For example, it is about 1 inch in diameter, approximately 2 inches in diameter or about 3 inches in diameter, but it could be larger or smaller depending on the desired application. A 1-inch dot is appropriate for a 100 square foot indoor space. Over 100 square feet, a 2-inch dot would be used. A 2-inch dot also could be used outside a structure, for example, placed on the ground about every 20 feet around the perimeter of the structure. As shown in FIG. 4, a 3-inch dot could be used under homes 62 or in attics or large open air rooms, with 1 dot placed in every 1,000 square foot area. In the 3-inch size, the dot can last up to 90 days. As shown in FIG. 3 The dot 50 should be placed around the plot of land 58 to be protected every 10-30 feet.

The dot delivery apparatus could be hung or otherwise placed in chicken houses to repel bugs of all types, or usable in barns or grazing fields for horses, cows, dogs, or anywhere else. The formulation also can be mixed with fine ground peat moss, and applied to fields, gardens etc., to repel all bugs and soil pathogens like nematodes. The product is also made as a broadcast form to be spread in a seed spreader. This repellent can be used in green houses to prevent bug damage. The product can be added to hanging baskets and sold as a bug repelling plant. Formulations described herein can also be mixed into freshly cut fields to replace pesticides.

The repellent embodiments described herein can repel any type of pest, including but not limited to, animals such as deer, geese, rabbits, rats, moles, mice, etc., insects, spiders, fleas, ticks, mosquitoes, flies, chiggers, gnats, lies, and nematodes.

Thus, it is seen that time release repellent formulations and methods are provided. It should be understood that any of the foregoing examples or chemical compounds may be interchangeably used with any of the systems of the preceding embodiments. Although illustrative embodiments of the present disclosure are described hereinabove, it will be evident to one skilled in the art that various changes and modifications may be made therein without departing from the disclosure. It is intended in the appended claims to cover all such changes and modifications that fall within the true spirit and scope of the disclosure.

What is claimed is:

1. A formulation comprising:
urine from a first animal in an amount effective to repel a second animal;
alum in an amount effective to keep microbial count below a pre-determined level; and
a natural binder;
wherein pH level is maintained within a pre-determined range by adding a natural acid to lower the pH level or adding a natural base to raise the pH level.

2. The formulation of claim 1 further comprising a natural oil.

3. The formulation of claim 2 wherein the natural oil is garlic oil.

4. The formulation of claim 1 wherein the natural binder is selected from the group consisting of: rice, pearlite, polymer, peat moss, clay and foam.

5. The formulation of claim 1 wherein the natural acid is citric acid.

6. The formulation of claim 1 wherein the natural base is soda ash.

7. The formulation of claim 1 wherein the first animal is selected from the group consisting of: fox and coyote.

8. A formulation comprising:
one or more natural oils;
alum in an amount effective to keep microbial count below a pre-determined level; and
a natural binder;
wherein pH level is maintained within a pre-determined range by adding a natural acid to lower the pH level or adding a natural base to raise the pH level.

9. The formulation of claim 8 further comprising one or more of: lemon grass and lemon eucalyptus.

10. The formulation of claim 8 wherein the one or more natural oils are selected from the group consisting of: cedar wood oil, garlic oil and castor oil.

11. The formulation of claim 8 wherein the natural binder is selected from the group consisting of: rice, pearlite, polymer, peat moss, clay and foam.

12. The formulation of claim 8 wherein the natural acid is citric acid.

13. The formulation of claim 8 wherein the natural base is soda ash.

14. A method of making a time release formulation comprising:
providing a natural repellent;
providing a natural binder;
optionally providing a natural antimicrobial agent;
combining the natural repellent, the natural binder and the natural antimicrobial agent;
maintaining pH level within a pre-determined range; and
drying the combined ingredients by pulling heated air through them.

15. The method of claim 14 wherein the natural repellent comprises animal urine or a natural oil.

16. The method of claim 14 wherein the natural binder is selected from the group consisting of: rice, pearlite, polymer, moss, clay and foam.

17. The method of claim 14 wherein the pH level is maintained by adding citric acid to lower the pH level or adding soda ash to raise the pH level.

18. The method of claim 14 wherein the drying step is performed using a drying apparatus.

19. The method of claim 14 wherein the drying apparatus comprises:
a drum;
a screened bottom;
a heater placed under the drum;
a fan placed on top of the drum;
wherein the combined ingredients are poured into the drum, and the fan pulls heated air upward through the combined ingredients to dry the combined ingredients.

20. A delivery method comprising:
injecting a time release formulation into a dot delivery apparatus; and
placing one or more dot delivery apparatus in the area to be protected from pests.
